(19) United States
(12) Patent Application Publication
(10) Pub. No.: US 2025/0187695 A1
(43) Pub. Date: Jun. 12, 2025

(54) SYSTEMS AND METHODS FOR A MULTI-MODE RIDE-ON DEVICE

(71) Applicant: Graco Children's Products Inc., Atlanta, GA (US)

(72) Inventors: Shahnaz Selena Kasam-Jayakumar, Atlanta, GA (US); Matthew A. Johnson, South Haven, MI (US); Andrew Q. Liu, Sandy Springs, GA (US); Mitren Thakor, Decatur, GA (US); Lauren Pusey, Roswell, GA (US)

(21) Appl. No.: 18/969,106

(22) Filed: Dec. 4, 2024

Related U.S. Application Data
(60) Provisional application No. 63/607,511, filed on Dec. 7, 2023.

(51) Int. Cl. B62K 13/08; B62B 7/04; B62B 7/06; B62B 7/12; B62B 7/14; B62K 9/02; B62K 13/04; B62K 15/00

(52) U.S. Cl. CPC B62K 13/08; B62B 7/044; B62B 7/06; B62B 7/12; B62B 7/145; B62K 9/02; B62K 13/04; B62K 15/006; B62K 2015/005

(57) ABSTRACT

A ride-on device with multiple modes and functions is provided. The ride-on device (e.g., ride-on toy) may transition between multiple modes such as a stroller mode with a seat and a pusher handle, a tricycle mode with a seat and a set of pedals on a front wheel, and a scooter mode with handle connected to a front wheel and a base for standing connected to the front wheel and having a set of back wheels. The ride-on device may include a base having multiple portions that may rotate with respect to one another to transition between the stroller, tricycle, and/or scooter modes. The ride-on device may include a wheel assembly with wheels that may be moved between different wheel positions. In one example, the wheel assembly may be rotated with respect to the base such that the base is positioned above the wheel assembly.

### CROSS REFERENCE TO RELATED APPLICATION

This application claims priority to and benefit of U.S. provisional patent application No. 63/607,511, filed Dec. 7, 2023, the entirety of which is hereby incorporated by reference.

### TECHNICAL FIELD

The present disclosure is generally in the field of infant and child ride-on devices and carriers, and more particularly related to ride-on and carrier devices having multiple riding modes.

### BACKGROUND

Ride-on toys are popular amongst young children and offer a safe way for a child to navigate their environment. For example, tricycles and scooters have long been popular choices for young children to safely move about indoor and outdoor spaces. Ride-on toys such as tricycles and scooters are both fun for children and promote exercise and learning. For example, tricycles and scooters may improve hand-eye coordination and balance of a young child. The skills learned from using tricycles and scooters may translate to more advanced ride-on vehicles such as balance bikes, bicycles, and/or more advanced two-wheeled scooters.

Before a young child has the strength and/or balance to ride a scooter and/or tricycle, the child may need their parent's or caretaker's help to get around. For example, strollers are commonly used to push a young child from one location to another. Strollers typically include three to four wheels, a seat for the young child, and an extended handle for the parent or caretaker to push the stroller.

Today tricycles, strollers, and scooters are entirely separate devices requiring the parent or caretaker to make three separate purchases. As each device may be expensive, owning all three devices can be cost prohibitive. Further, some environments may be more suitable for a tricycle and others for a stroller. Also, a child may want to use both a and thus it may be desirable to travel with both. However, it may be difficult to travel with a tricycle, stroller, and a scooter due to space constraints (e.g., in a car).

A need remains for a ride-on device that has multiple riding modes and/or functions. More specifically, it may be desirable for a ride-on device to function as a stroller, a tricycle, and a scooter.

### SUMMARY

The present disclosure describes a ride-on device that is designed to transition between multiple modes with varying functions. For example, the ride-on device may include a stroller mode which may support a seated child and may have a pusher handle for a caretaker to push, a tricycle mode including three wheels, a handle, a seat and a set of pedals, and/or a scooter mode having handle, base for standing and a set of wheels.

In embodiments, the present disclosure describes a device for transporting a user including a base designed to support the user, the base having a first portion and a second portion, the first portion designed to rotate with respect to the second portion to transition between a first base position and a second base position, a handle assembly coupled to the base and having a wheel and a handle, and a wheel assembly with a set of wheels, the wheel assembly coupled to the base and designed transition between a first wheel position and a second wheel position. The base may be designed to transition between the first base position and second base position and the wheel assembly may be designed to between the first wheel position and the second wheel position to form a first orientation configured to support the user in a seated position and a second orientation configured to support the user in a standing position.

In embodiments, the present disclosure describes a device for transporting a user including a handle assembly having a wheel, a shaft coupled to the wheel, and a handle coupled to the shaft, a base designed to support the user and to selectively couple to the shaft at a first shaft position and a second shaft position, the shaft designed to rotate with respect to the base, and a wheel assembly having a first arm coupled to a first wheel and a second arm coupled to a second wheel, the wheel assembly coupled to the base and designed rotate with respect to the base between a first wheel position and a second wheel position. The device may be designed to transition from a first orientation designed to support the user in a seated position when the base is positioned at the first shaft position and the wheel assembly is positioned in the first wheel position to a second orientation designed to support the user in a standing position when the base is positioned at the second shaft position and the wheel assembly is positioned in the second wheel position.

### BRIEF DESCRIPTION OF THE DRAWINGS

The detailed description is set forth with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIGS. 1A-1D are perspective views of a multi-mode ride-on device in stroller, tricycle, balance bike, and scooter mode.

FIGS. 2A-2F are perspective views of another multi-mode ride-on device in stroller, tricycle, balance bike, and scooter mode.

FIGS. 3A-3D are perspective views of another multi-mode ride-on device in stroller, tricycle, balance bike, and scooter mode.

FIGS. 4A-4E are perspective views of another multi-mode ride-on device in stroller, tricycle, balance bike, and scooter mode.

FIGS. 5A-5D are perspective views of another multi-mode ride-on device in stroller, tricycle, and scooter mode.

FIGS. 6A-6H are perspective views of another multi-mode ride-on device in stroller, tricycle, balance bike, and scooter mode.

The present disclosure provides a more detailed and specific description with reference to the accompanying drawings. The drawings and specific descriptions of the drawings, as well as any specific or other embodiments discussed, are intended to be read in conjunction with the entirety of this disclosure.

### DETAILED DESCRIPTION

Example embodiments will now be described more fully hereinafter with reference to the accompanying drawings, in which example embodiments are shown. The concepts disclosed herein may, however, be embodied in many different forms and should not be construed as limited to the example embodiments set forth herein; rather, these embodiments are provided so that this disclosure will be thorough and complete, and will fully convey the scope of the concepts to those skilled in the art. Like numbers refer to like, but not necessarily the same or identical elements throughout.

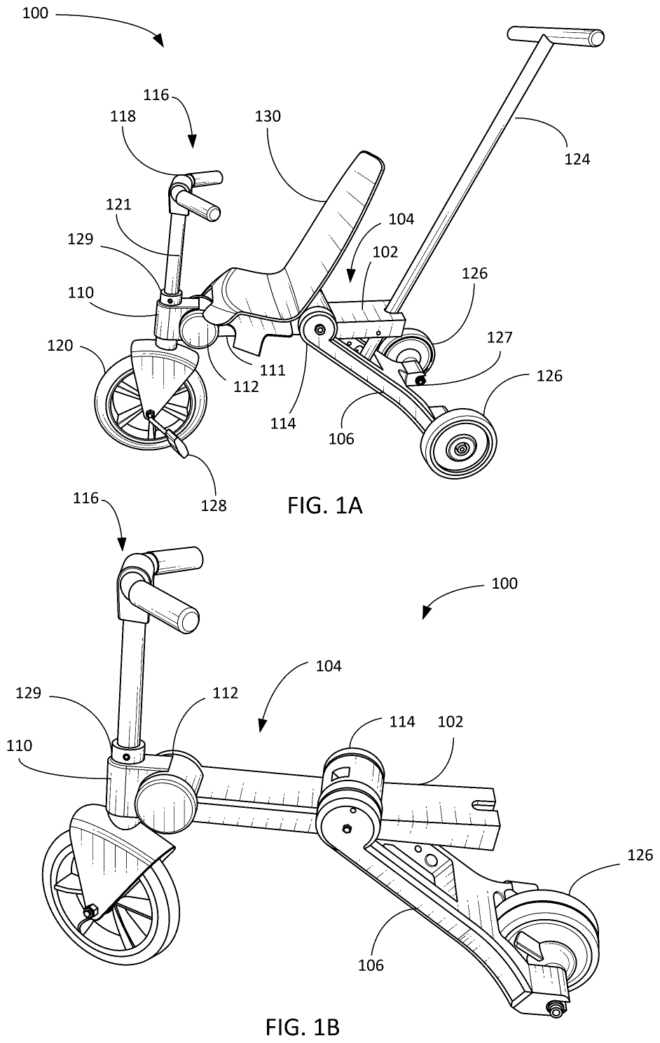

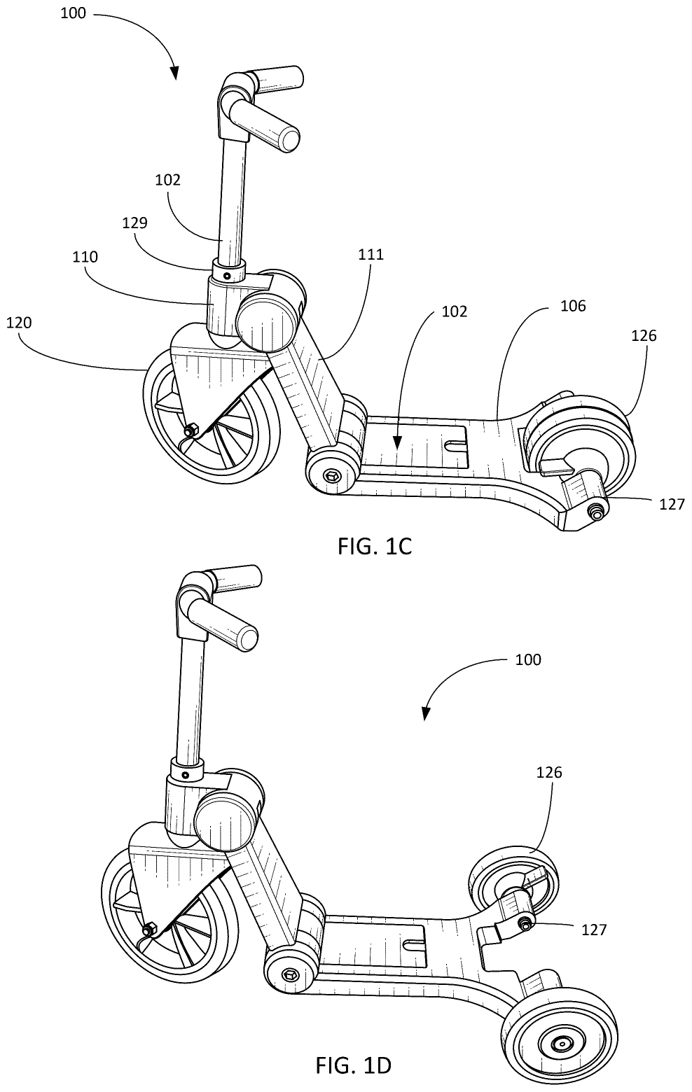

Referring now to FIGS. 1A-1D, perspective views of a multi-mode ride-on device in stroller, tricycle, balance bike, and scooter mode are illustrated. Ride-on device 100 may be intended for a young child such as a toddler, for example, and may transition between multiple modes or positions. For example, ride-on device 100 may include a stroller mode, a tricycle mode, a balance bike mode, and a scooter mode.

Ride on device 100 may include base 104, set of wheels 126, wheel 120, handle assembly 116, pusher 124, and/or seat 130. Base 104 may have multiple portions connected by hinges that may be independently rotated and locked to assume various base positions. Base portion 106, base portion 102, base portion 111, and/or base portion 110 may be connected via hinges and independently rotatable. For example, base 104 may include base portion 102 and base portion 111 connected to base portion 106 via hinge 114 and base portion 110 connected to base portion 102 via hinge 112.

Base portion 111 may support seat 130 which may be any suitable scat for supporting a young child. Scat 130 may include a snap fit, form fit, buckle, spring engagement and/or any other suitable mating feature to removably fix seat 130 to base 104. Seat 130 may include cushions and/or safety belts. Base 104 may connect to pusher 124 which may be a handle that can be removably connected to base 104. Pusher 124 may be extendable and may have a height suitable to be pushed by an adult.

Base portion 106 may be positioned near the rear of ride-on device 100 and may include wheel engagement features 127 at a free end to engage with set of wheels 126. Base portion 106 may rotate with respect to base portion 102. Wheels 126 of set of wheels 126 may connect to engagement features 127 via a threaded engagement, a spring engagement, a snap fit, and/or any other suitable engagement feature for connecting the wheels to engagement features 127. Wheels of set of wheels 126 may include two wheels, for example. In one example, set of wheels 126 and engagement features 127 may be a wheel assembly.

Engagement features 127 may be positioned on an interior of engagement features 127, as shown in FIG. 1B, or on an exterior of engagement features 127, as shown in FIG. 1A. Base portion 110 may rotate with respect to base portion 102 via hinge 112. Base portion 110 may receive handle assembly 116 or a portion thereof. Handle assembly 116 may include shaft 121 and handle 118. Handle assembly 116 may also include wheel 120 and/or pedal 128. Base portion 110 may include connector 129 and handle assembly may include shaft 121 that extends through handle portion 110 and/or connector 129. Connector 129 may lock base portion 110 at certain positions with respect to shaft 121. Connector may be any suitable tightening lock and/or pin connector.

Handle 118 may be any suitable handle for turning shaft 121. For example, handle 120 may include two grip portions. Shaft 121 may extend through base portion 110 and may connect to wheel 121. Wheel 121 may rotate with respect to shaft 102 along one axis and may be fixed to shaft 121 along a different axis to permit handle assembly 116 to turn wheel 120. Wheel 120 may include pedals 128 that may be rigidly attached to wheel 120 such that rotation of pedals 128 may cause rotation of wheel 120. In one example, pedals 128 may be selectively engaged and disengaged with wheel 120 and/or disconnected from wheel 120.

Referring now to FIG. 1A, ride-on device 100 is illustrated in stroller mode and/or tricycle mode. In the position illustrated in FIG. 1A, ride-on device 100 has base portion 106 rotated below base portion 102 and base portion 111 such that base portion 102 is positioned above wheels 126. Wheels 126 are secured to an outer portion of engagement feature 127 to provide a wide wheelbase for stability. Hinges 114 and 112 may be locked into position to secure ride-on device 100 in stroller and/or tricycle mode.

In stroller mode, pusher 124 may be coupled to base 104 (e.g., at base portion 102 and/or base portion 106). Stroller mode may not have pedals 128 and/or pedals 128 may be disengaged from a hub of wheel 120 such that rotation of pedals 128 does not cause rotation of wheel 120 and vice versa. To transition to tricycle mode, pusher 124 may be removed. In tricycle mode, pedals 128 may be connected to or otherwise engaged with wheel 120 and/or a hub of wheel 120. In both stroller and tricycle mode, seat 130 may be secured to base 104.

Referring now to FIG. 1B, ride-on device 100 may be transitioned into balance bike mode. When ride-on device 100 is in balance bike mode, wheels 126 may be connected to an interior portion of engagement feature 127 and seat 130 may be removed. For example, wheels 126 may be disconnected from an outer portion of engagement feature 127 on base portion 106 and may be moved to the interior portion of engagement feature 127. In balance bike mode, base portion 106, base portion 102, hinge 114, hinge 112, and/or base portion 111 may be in the same position and/or orientation as stroller and/or tricycle mode.

Referring now to FIG. 1C, ride-on device 100 is illustrated in scooter mode. As shown in FIG. 1C, in scooter mode, wheels 126 are secured to an internal portion of the engagement features, such that wheels 126 are adjacent to one another. Base portion 102 may be flush with base portion 106 to support a user in a standing position. Base portions 102 and 106 may be positioned below a top portion of wheels 126. Base portion 111 may extend between base portion 106 and base portion 110.

Base portion 111 may be positioned at the same height as base portion 110 when ride-on device 100 is in stroller or tricycle mode (e.g., just above wheel 120). To enhance balance in the scooter mode, wheels 126 of ride-on device may be adjusted such that wheels 126 are secured at an outer portion of engagement feature 127, as shown in FIG. 1D. The wide wheelbase shown in FIG. 1D may be suitable for a toddler learning to ride a scooter, whereas ride-on device 100 shown in FIG. 1C may be suitable for an older child. It is understood that any other combination of positions of ride-on device 100 may be achieved.

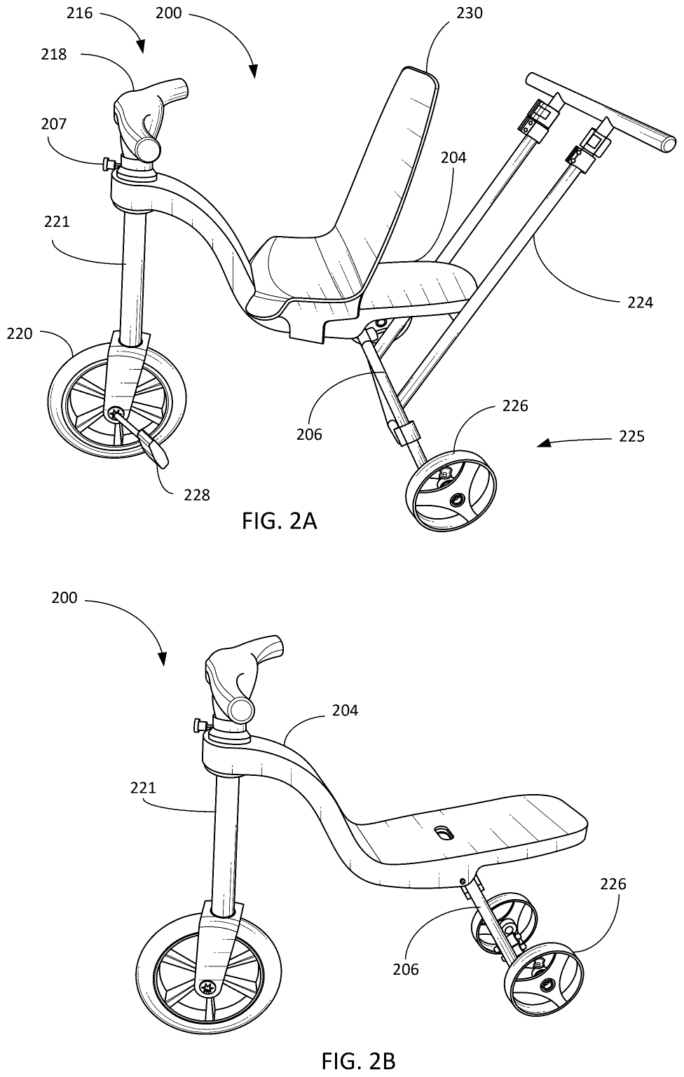

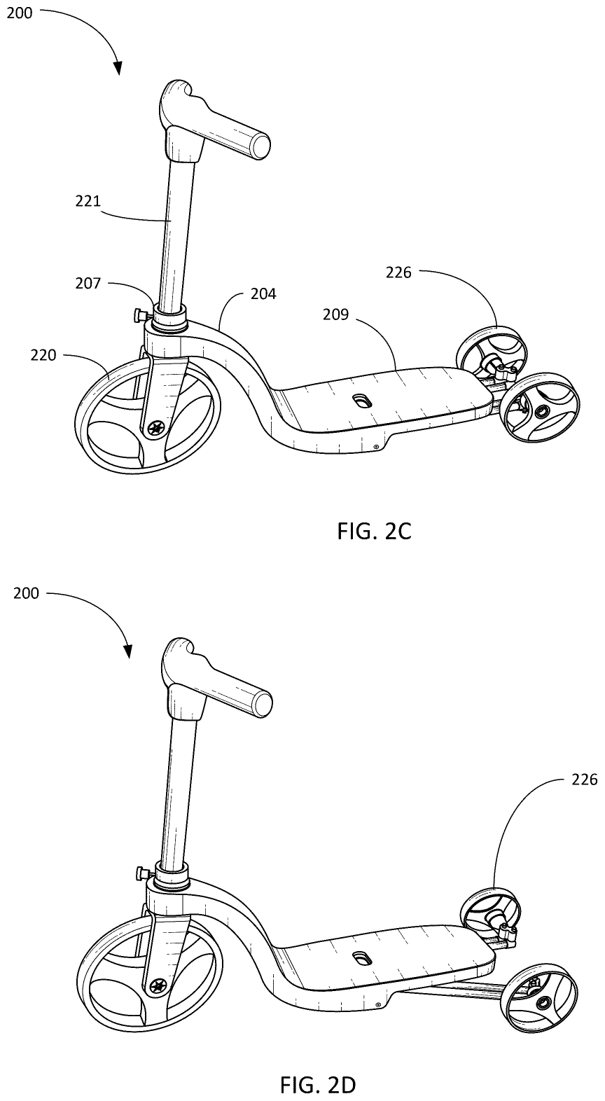

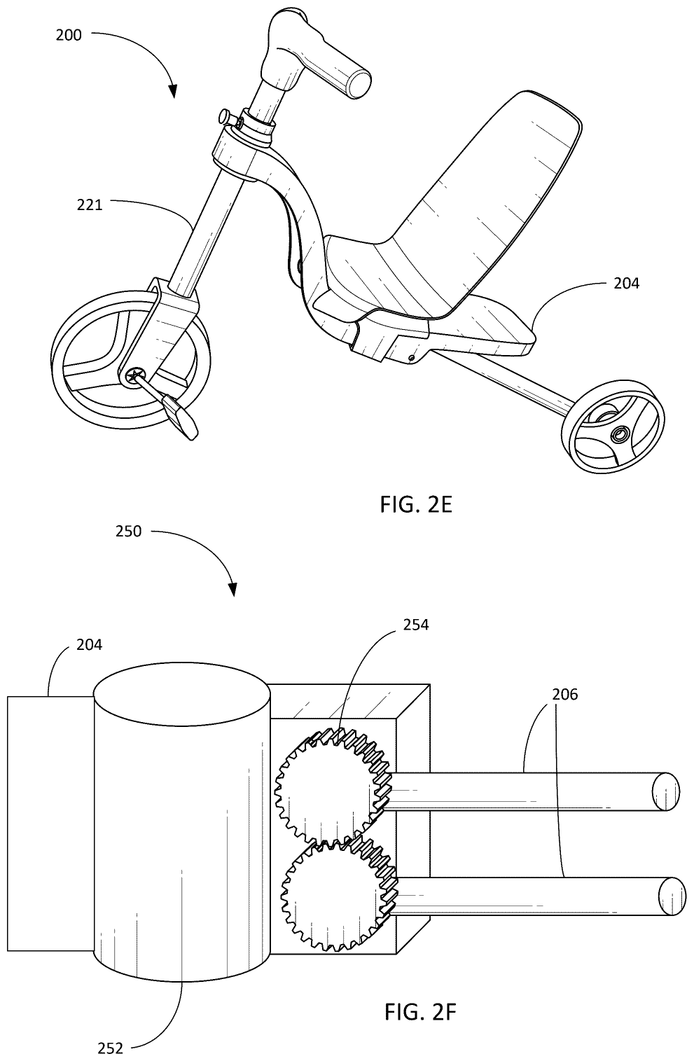

Referring now to FIGS. 2A-B, perspective views of another multi-mode ride-on device in stroller, tricycle, balance bike, and scooter mode are illustrated. Ride-on device 200 may be similar to ride on device 100 of FIG. 1. For example, handle assembly 216 may include handle 218 and shaft 121 and may be the same as or similar to handle assembly 116 of FIG. 1. Wheel 220 and/or pedals 228 may also be included in handle assembly 216 and may be the same as or similar to wheel 120 and pedals 128 of FIG. 1. Seat 230 and/or pusher 224 may be the same as or similar to seat 130 and pusher 124 of FIG. 1.

Base portion 204 may receive shaft 221 at one end and may be coupled to seat 230, which may be removed. Base portion 204 may be a single unitary portion. Base portion may include a guide shaft through which shaft 221 may enter and lock 207 which may lock base portion to shaft 221 at a certain height or position along shaft 221. Wheel assembly 225 may extend from a rear portion of base portion 204 and may include wheel arms 206 and wheels 226.

Wheel arms 206 may be connected at one end (e.g., via gears) to base portion 204 and may be connected at another end to one of wheels 226. Arms 206 may rotate together with respect to base 204 and/or may move apart from one another and close together. Wheel assembly 225 may be locked into place with respect to base 204 when a desired arm position and/or wheel position is achieved.

Referring now to FIG. 2A a tricycle and/or stroller mode is illustrated. As shown in FIG. 2A, base 204 may be positioned above wheels 226 and lock may lock base portion 204 adjacent to or near handle 218. Wheels 226 may be spread apart from one another. To transition ride-on device 200 to a balance bike mode shown in FIG. 2B, seat 230 may be removed and wheels 226 may be moved close to another. For example, wheels 206 may be positioned adjacent to one another.

Referring now to FIG. 2C, to transition ride-on device 200 to a scooter mode, base portion may be lowered with respect to shaft 221 and wheels 226 such that support portion 209 for supporting a user in standing position is lowered below a portion of wheels 226 and base 204 is positioned adjacent to and/or immediately above wheel 220. To improve stability of ride-on device 200, wheels 226 may be positioned apart further from one another and locked into place, as shown in FIG. 2D. It is understood that any other combination of positions of ride-on device 200 may be achieved. For example, FIG. 2E illustrates a lowered tricycle position with base 204 connected to shaft 221 at a high position but with wheels 226 rotated upward toward base 204.

Referring now to FIG. 2F, assembly 200 may be used to rotate and move the wheel assembly. For example, hinge 252 may connect to base 204 and the wheel assembly and permit the wheel assembly to rotate with respect to the base. Assembly may include gears 254 which may be rotated with respect to hinge 252 and may include two gears, for example, each mechanically connected to an arm of arms 206. Each arm may be connected to a wheel. In this manner, arms 206 may rotate with respect to base 204 and may move apart from one another in unison.

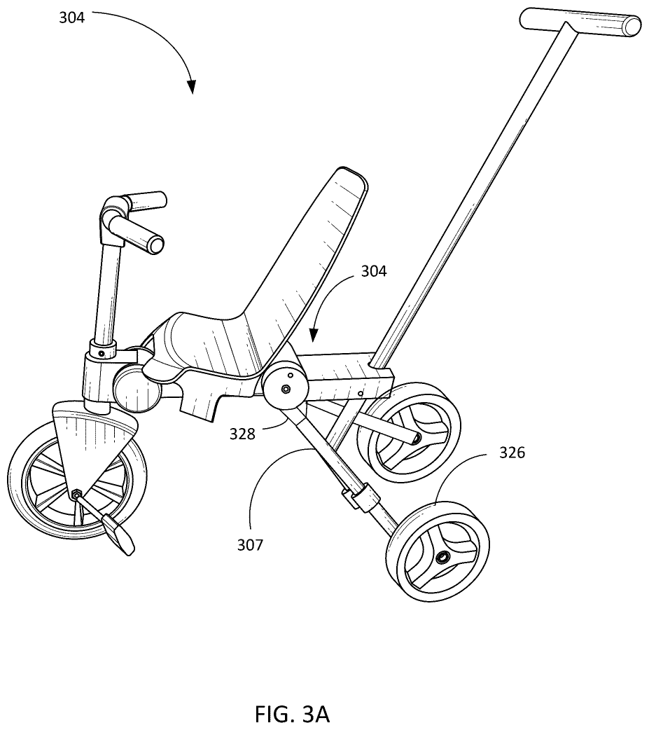

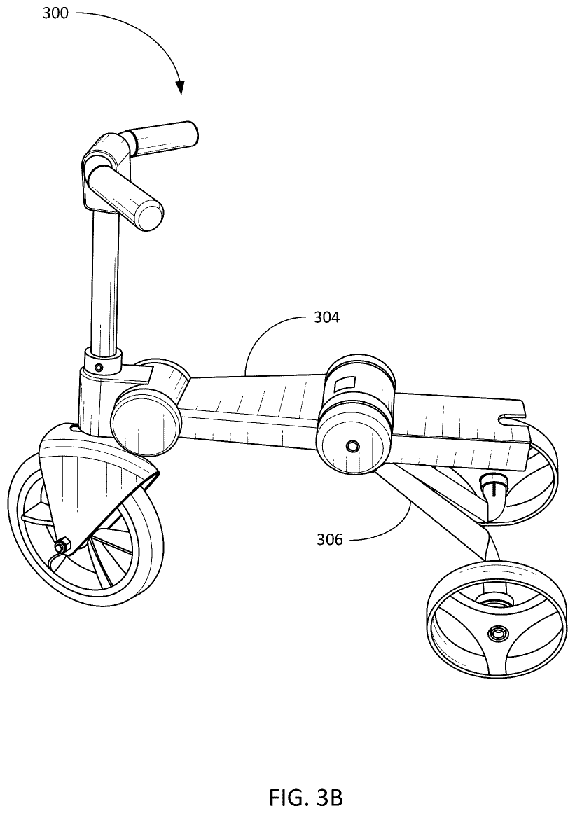

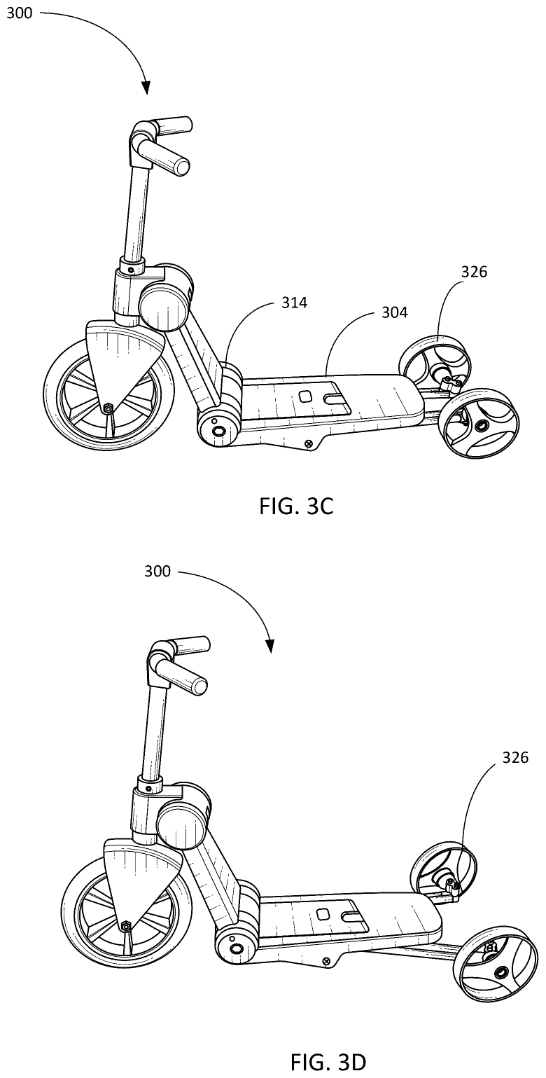

Referring now to FIGS. 3A-3D, perspective views of another multi-mode ride-on device in stroller, tricycle, balance bike, and scooter mode are illustrated. Ride-on device 300 may be similar to ride on device 100 of FIG. 1, but may include arms 206 and wheels 226 of ride-on device 200 of FIG. 2A. As shown in FIG. 3A, arms 307 may be the same or similar to arms 206 of FIG. 2A and may connect to assembly 328 which may be the same as or similar to assembly 250 of FIG. 2A. Assembly 238 may be rotatably connected to base 304, which may be the same as base 104 of the ride-device in FIG. 1. Arms 307 may rotate with respect to base 304 and may move apart from another. The stroller and/or tricycle mode (e.g., without pusher 324) of ride-on device 300 is illustrated in FIG. 3A.

Referring now to FIG. 3B, a balance bike mode of ride-on device 300 is illustrated with arms 307 moved towards one another and the seat removed from the tricycle position. As shown in FIG. 3B, base 304 may optionally not include base portion 206 of FIG. 2A. To transition ride-on device 300 to a scooter mode, base portion 304 may be adjusted such that base portion 306 is rotated with respect to hinge 314 such that base portion 306 is positioned below a portion of wheels 326. The arms of the wheel assembly may up towards base 304. As shown FIG. 3D, wheels 326 may be separated apart to improve stability of ride-on device 300. It is understood that any other combination of positions of ride-on device 300 may be achieved.

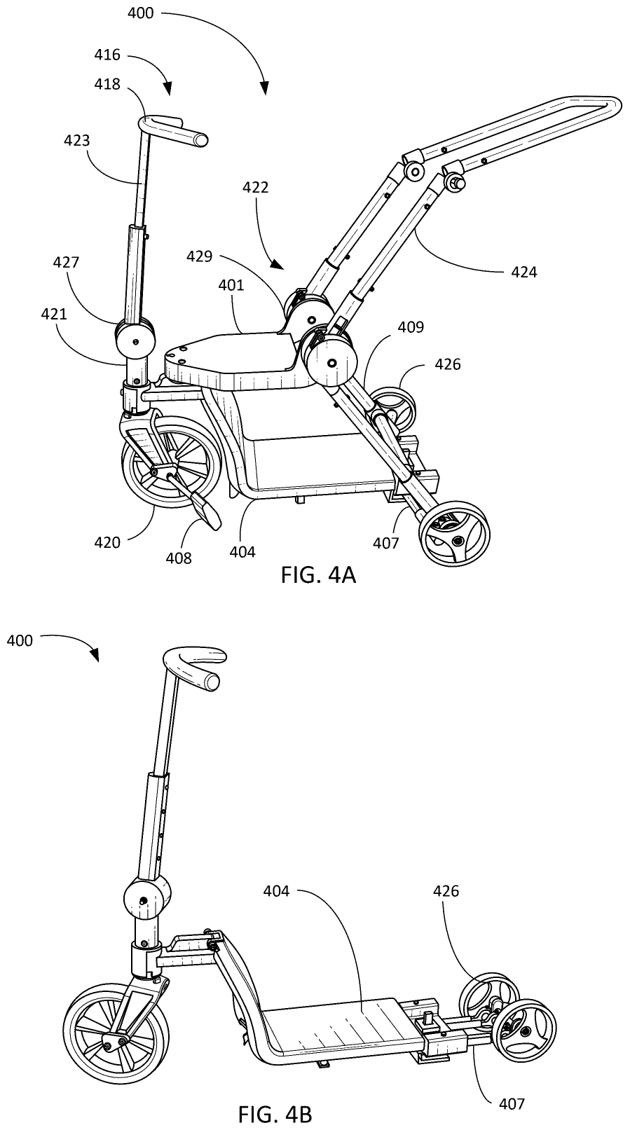

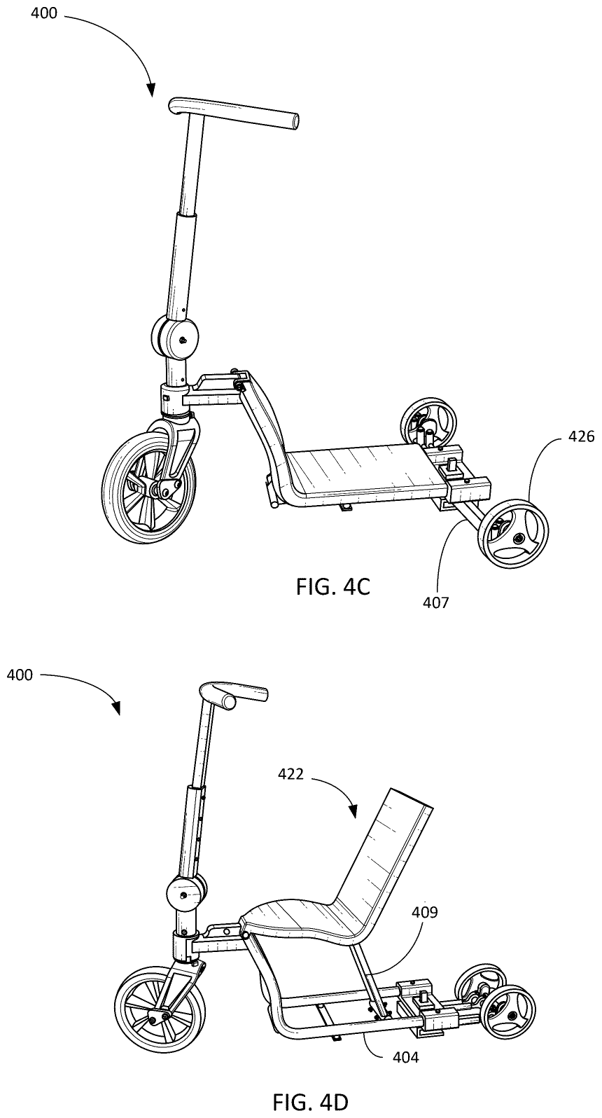

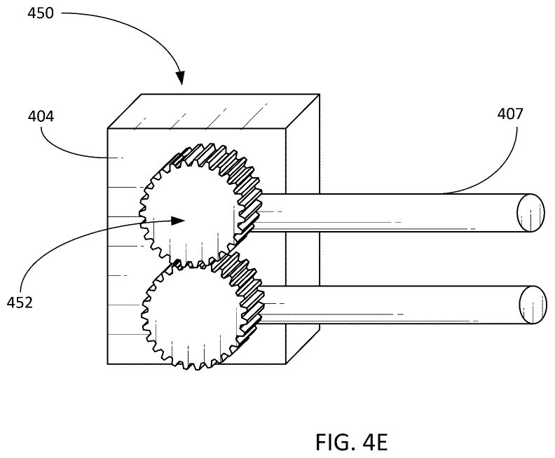

Referring now to FIGS. 4A-4E, perspective views of another multi-mode ride-on device in stroller, tricycle, balance bike, and scooter mode are illustrated. Ride-on device 400 may be similar to ride-on device 200 of FIG. 2. For example, ride-on device 400 may include base 404, which may be similar to base 204 of FIG. 2 and/or may be a unitary piece for supporting a user. Base 404 may be designed to receive shaft 421 and may be secured to shaft 421 such that shaft 421 may rotate with respect to base 404.

Shaft 421 may be part of handle assembly 416, which may also include handle 418 upper shaft 423 and hinge 427. Hinge 427 may connect shaft 421 and upper shaft 423 and may permit shaft 421 to rotate with respect to upper shaft 423. Upper shaft 423 and/or shaft 421 may be telescoping. Shaft 421 may be connected to wheel 420 and may cause wheel 420 to turn as shaft 421 turns. Wheel 420 may be connected to pedals 408, which may be selectively engaged or connected with wheel 420.

Seat assembly 422 may be secured to base 404 and may include seat portion 401, pusher portion 424 and legs 407. Seat 401 may be removably connected to base 404 (e.g., via a threaded engagement, spring engagement, form fit, snap fit, and/or any other suitable technique). Seat 401 may be connected to legs 407 which may rotate with respect to hinge 429 which may be connected to seat portion 401 and permit legs 409 to rotate and lock with respect to seat portion 401. Pusher 424 may be also extend from hinge 429 and rotate and lock with respect to hinge 429. Seat portion 401 may support a user in a seated position.

Arms 407 may include two arms that extend from a rear portion of base 404 and may rotate towards and away from one another in unison (e.g., via gears at one end of arms 407). Arms 407 may be connected to wheels 426 at one end and gears at another end. Legs may be connected to arms 407. Arms 407 may be locked to maintain wheels 426 in a desired position.

To transition ride-on device 400 to a scooter mode illustrated in FIG. 4B, wheels 426 and arms 407 may be moved together such that wheels 426 are adjacent to one another. Further, seat assembly 422 may be removed from base 404. To improve stability of the scooter, wheels 426 and legs 407 may be moved apart from one another as shown in FIG. 4C.

It is understood that any other combination of positions of ride-on device 400 may be achieved. For example, FIG. 4D seat assembly 422 attached to base 404 in scooter mode. Referring now to FIG. 4E, assembly 450 is illustrated. Assembly 450 illustrates an exemplary connection between arms 407 and base 404. For example, arms 407 may be connected to base 404 via gears 452 which may be connected at an end of each of arms 407. In this manner, arms 407 may move apart and together in unison.

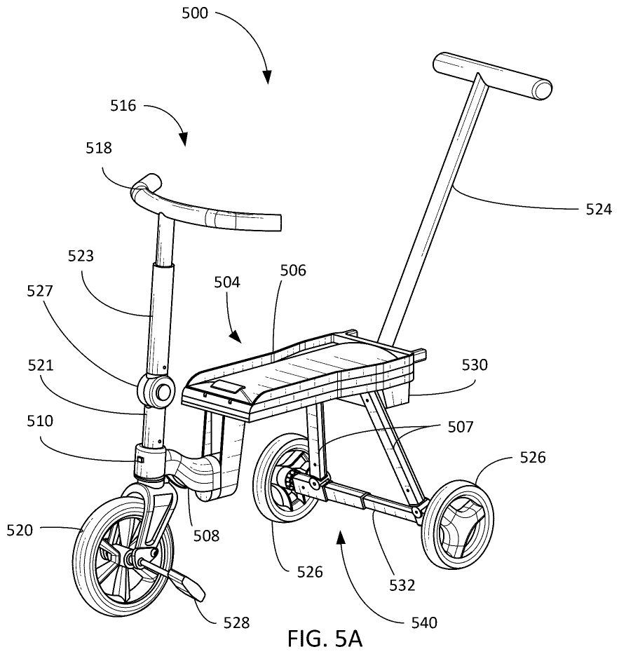

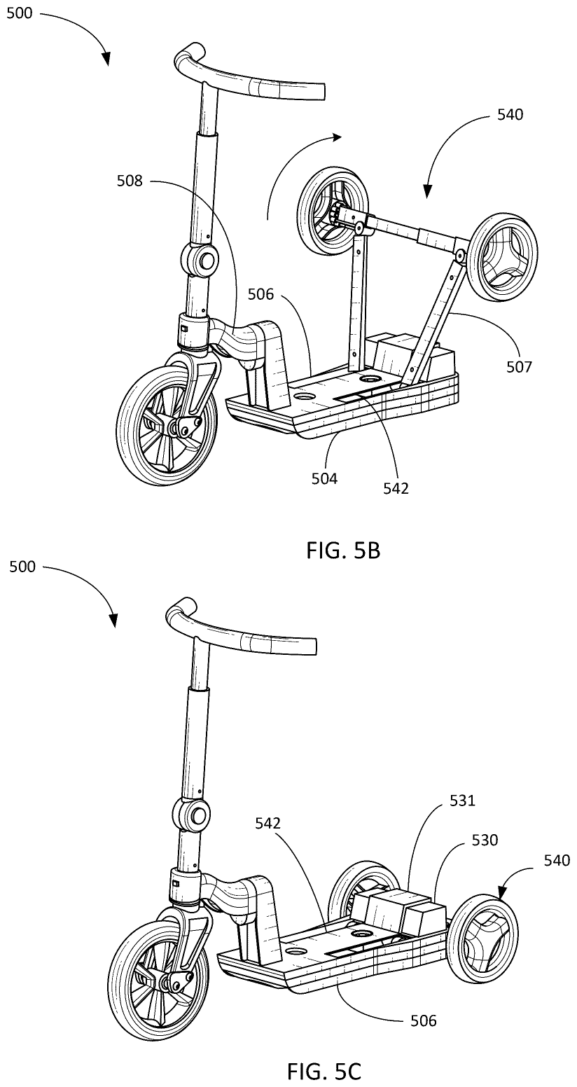

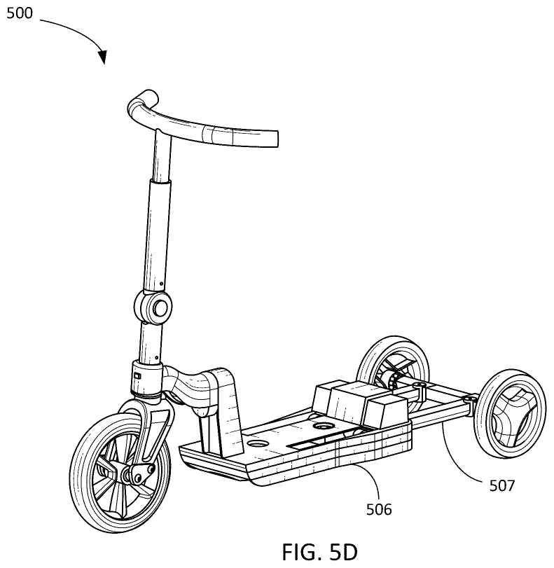

Referring now to FIGS. 5A-5D, perspective views of another multi-mode ride-on device in stroller, tricycle, balance bike, and scooter mode are illustrated. Ride-on device 500 may include base 504, which may support a user (e.g., young child, toddler, etc.) which may include support portion 505 and connection portion 508. Support portion 506 may include a top side for seating and bottom side for standing and may be rotatably connected to connection portion 508.

Connection portion 508 may include a receiving channel for receiving shaft 521 which may rotate within connection portion 508. Shaft may be included in handle assembly 516, which may further include handle 518 connected to shaft 523 and hinge 527 which may be connected to shaft 523 and shaft 521. Shaft 523 and shaft 521 may be telescoping and/or may rotate with respect to one another via hinge 527, which may be locked in a desired position. Shaft 521 may be connected to wheel 520 which may be turned via handle 518. Pedals 528 may be selectively connected to and/or engaged with wheel 520.

Pusher 524 may be removably connected to base 504 and may be used by an adult to push ride-on device 500. Wheel assembly 540 may be connected to the underside of support portion 506 and may include arms 507 connected at one end to the underside of support portion 506. Wheels 526 may be connected via wheel connector 532, which may be telescoping. Wheel connector may optionally be biased (e.g., via a spring) to push wheels 526 apart. Stopper 530 may have sloped surface to maintain arms 507 in a desired position.

Ride-on device 500 is illustrated in the stroller and/or tricycle mode or position in FIG. 5A. To transition to the tricycle mode, pusher 524 may be disconnected from base 504. To transition from tricycle or stroller mode to scooter mode, base 504 may be rotated with respect to connection portion 508 to position the underside of support portion 504 upright. Support portion 504 may include channels 542 in which arms 507 may be positioned as wheel assembly 542 is rotated with respect to support portion 506.

As shown in FIG. 5C, arms may be fit entirely within channels and stoppers may be caused to move inward in housing 531 to move the arms beyond stoppers 530. For example, stoppers 530 may include spring components and may be biased outwards. To improve stability of ride-on device 500, arms 507 may be extended outward from base portion 506 as shown in FIG. 5D. It is understood that any other combination of positions of ride-on device 500 may be achieved.

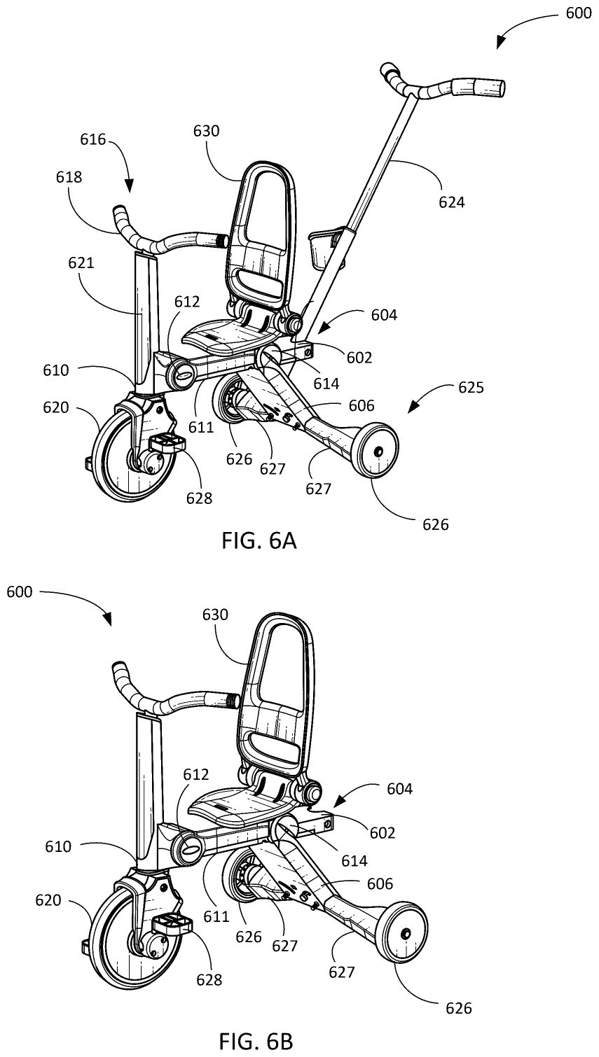

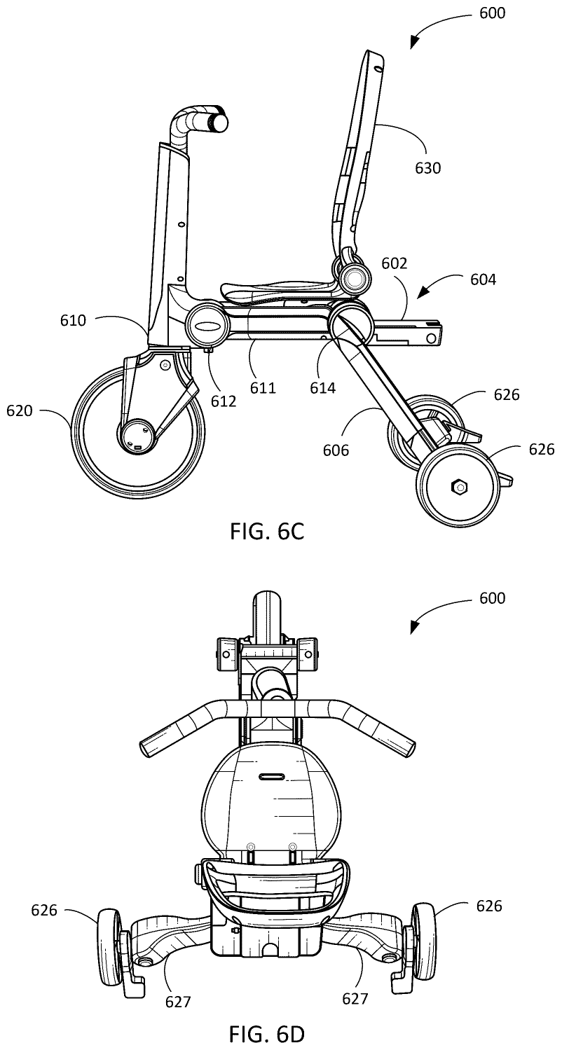

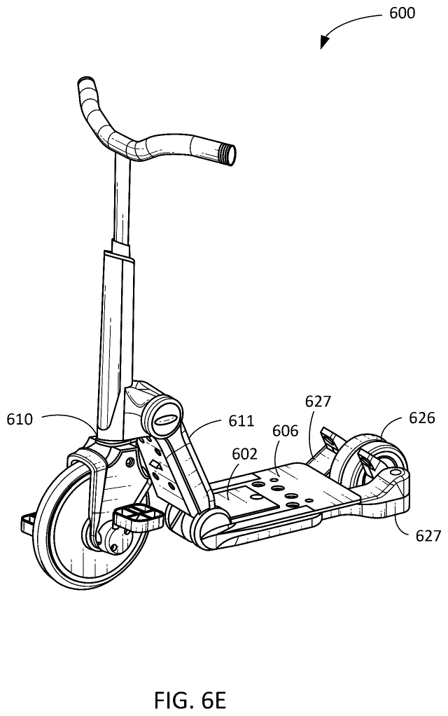

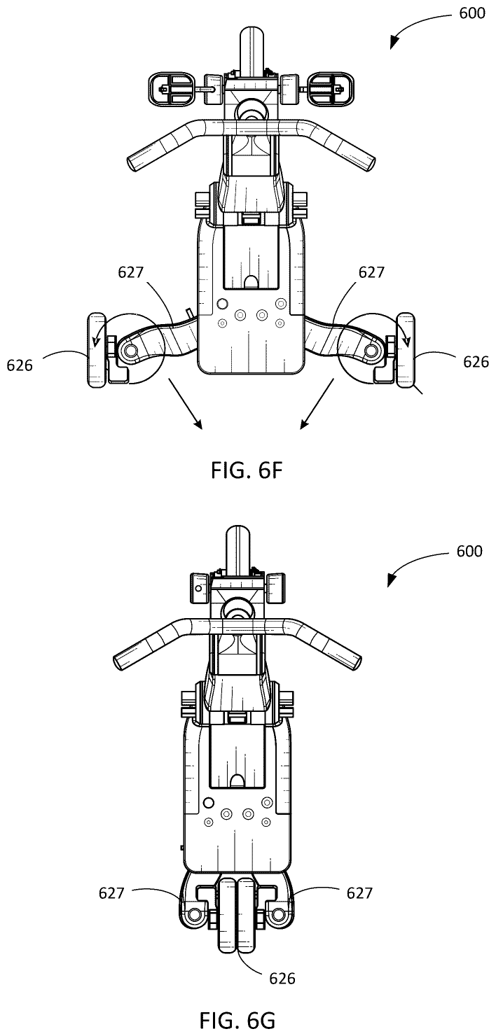

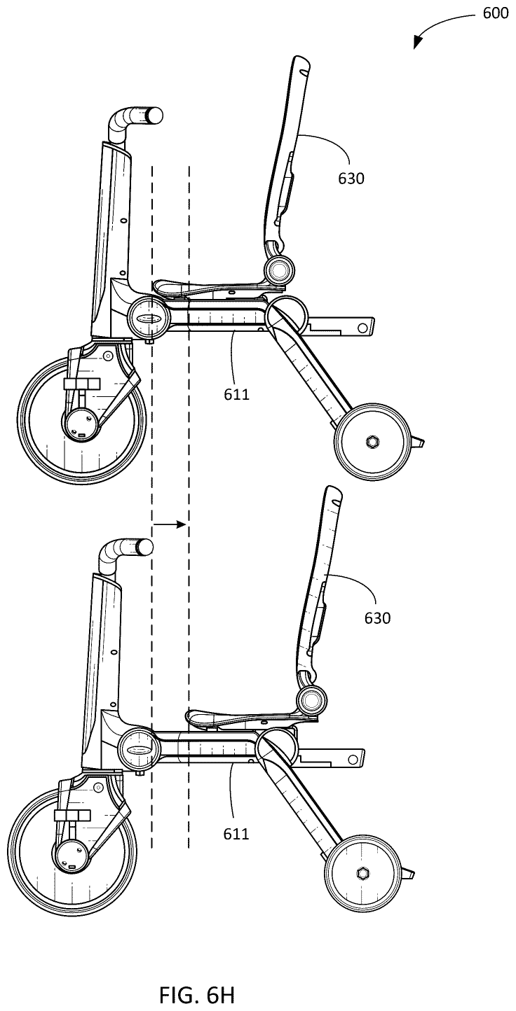

Referring now to FIGS. 6A-6H, perspective views of another multi-mode ride-on device in stroller, tricycle, balance bike, and scooter mode are illustrated. Ride-on device 600 may be similar to ride on device 100 of FIG. 1. For example, base 604 may include base portion 602 and base portion 611 connected to base portion 606 via hinge 614 and base portion 610 connected to base portion 602 via hinge 612 and may be the same as or similar to base portion 104, hinge 114, and hinge 112 of FIG. 1. Handle assembly 616 may include a handle 618 and shaft 621 and may be the same as or similar to handle assembly 116 of FIG. 1. Wheel 620 and pedals 628 may also be included in handle assembly 616 and may be the same as or similar to wheel 120 and pedals 128 of FIG. 1.

Base portion 611 may support seat 630 which may be any suitable seat for supporting a young child. Support seat 630 may be adjusted along base portion 611, as will be described in greater detail with reference to FIG. 6H. Seat 630 may include a snap fit, form fit, buckle, spring engagement and/or any other suitable mating feature to removably fix seat 630 to base 604. Seat 630 may include cushions and/or safety belts. Base 604 may connect to pusher 624 which may be a handle that can be removably connected to base 604. Pusher 624 may be extendable and may have a height suitable to be pushed by an adult.

Base portion 606 includes wheel assembly 625. Wheel assembly 625 may include a set of wheel arms 627 and a set of wheels 626. Wheel arms 627 may be connected at one end to base portion 606 and may be connected at another end to one of the wheels 626. Wheel arms 627 may be connected to base portion 606 near the bottom end of base portion 606 and may rotate together with respect to base portion 606.

Referring now to FIG. 6A, ride-on device 600 is illustrated in stroller mode. When ride-on device 600 is in stroller mode, seat 630 may be secured to base 604. In the position illustrated in FIG. 6A, ride-on device 600 has base portion 606 rotated below base portion 602 and base portion 611 such that base portion 602 is positioned above wheels 626. Wheel arms 627 may extend from base portion 606 and wheels 626 may be positioned on an outer portion of wheel arms 627 such that wheels 626 are spaced apart from one another.

In stroller mode, pusher 624 may be coupled to base 604 (e.g., at base portion 602 and/or base portion 606). Stroller mode may not have pedals 628 and/or pedals 628 may be disengaged from a hub of wheel 620 such that rotation of pedals 628 does not cause rotation of wheel 620 and vice versa.

Referring now to FIG. 6B, ride-on device 600 is illustrated in tricycle mode. To transition to tricycle mode, pusher 624 may be removed. In tricycle mode, pedals 628 may be connected to or otherwise engaged with wheel 620 and/or a hub of wheel 620. In tricycle mode, wheels 626, wheel arms 627, seat 630, base portion 602, base portion 606, base portion 610, base portion 611, hinge 614, and/or hinge 612 may be in the same position and/or orientation as stroller mode, illustrated in FIG. 6A.

Referring now to FIGS. 6C-6D, ride-on device 600 may be transitioned into balance bike mode. When ride-on device 600 is in balance bike mode, pedals 626 may be removed from wheel 620. In balance bike mode, wheels 626, wheel arms 627, seat 630, base portion 602, base portion 606, base portion 610, base portion 611, hinge 614, and/or hinge 612 may be in the same position and/or orientation as stroller and/or tricycle mode, illustrated in FIGS. 6A and 6B.

Referring now to FIG. 6E, ride-on device 600 is illustrated in scooter mode. When ride-on device 600 is in scooter mode, seat 630 may be removed. Base portion 602 may be flush with base portion 606 to support a user in a standing position. Base portions 602 and 606 may be positioned below a top portion of wheels 626. Base portion 611 may extend between base portion 606 and base portion 610.

Wheels 626 may be rotated about wheel arms 627 such that wheels 626 may be positioned on an inner portion of wheel arms 627 and wheel arms 627 may rotate about base portion 606 such that wheels 626 are adjacent to each other, as shown in FIGS. 6F-6G. To improve stability of ride-on device 600, wheels 626 may be in the same position and/or orientation as stroller and/or tricycle mode, as illustrated in FIG. 6F. The wide wheelbase shown in FIG. 6F may be suitable for a toddler learning to ride a scooter, whereas ride-on device 600 shown in FIG. 6E may be suitable for an older child. It is understood that any other combination of positions of ride-on device 600 may be achieved.

Referring now to FIG. 6H, seat 630 may be adjusted in stroller and/or tricycle mode to positions that are most suitable for a user. In one embodiment, seat 630 is slidably coupled to base portion 611 such that seat 630 can move between various positions along base portion 611. For example, seat 630 may slide from a first position near the front of base portion 611 to a second position near the rear of base portion 611 to better fit an older child. In another embodiment, a user may remove seat 630 from base portion 611 at a first position and may fix seat 630 to base portion 611 at a second position more suitable for a child. Seat 630 may include a snap fit, form fit, buckle, spring engagement and/or any other suitable mating feature to removably fix seat 630 at various positions along base portion 611. It is understood that the position of seat 630 can be adjusted using any suitable means to move a position of seat 630 along base portion 611.

Though the disclosed examples include particular arrangements of a number of parts, components, features, and aspects, the disclosure is not limited to only those examples or arrangements shown. Any one or more of the parts, components, features, and aspects of the disclosure may be employed alone or in other arrangements of any two or more of the same.

Although certain product features, functions, components, and parts have been described herein in accordance with the teachings of the present disclosure, the scope of coverage of this patent is not limited thereto. On the contrary, this patent covers all embodiments of the teachings of the disclosure that fairly fall within the scope of permissible equivalents.

Unless otherwise noted, the terms used herein are to be understood according to conventional usage by those of ordinary skill in the relevant art. In addition to the definitions of terms provided below, it is to be understood that as used in the specification and in the claims, “a” or “an” may mean one or more, depending upon the context in which it is used.

Throughout this application, the term “include,” “include(s)” or “including” means “including but not limited to.” Note that certain embodiments may be described relating to a single glass, but the corresponding description should be read to include embodiments of two or more glasses. Different features, variations, and multiple different embodiments are shown and described herein with various details. What has been described in this application at times in terms of specific embodiments is done for illustrative purposes only and without the intent to limit or suggest that what has been conceived is only one particular embodiment or specific embodiments. It is to be understood that this disclosure is not limited to any single specific embodiments or enumerated variations. Many modifications, variations and other embodiments will come to mind of those skilled in the art, and which are intended to be and are in fact covered by this disclosure. It is indeed intended that the scope of this disclosure should be determined by a proper legal interpretation and construction of the disclosure, including equivalents, as understood by those of skill in the art relying upon the complete disclosure present at the time of filing.

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language generally is not intended to imply that features, elements, and/or operations are in any way required for one or more implementations or that one or more implementations necessarily include logic for deciding, with or without user input or prompting, whether these features, elements, and/or operations are included or are to be performed in any particular implementation.

What has been described herein in the present specification and drawings includes examples of systems, apparatuses, methods, devices, and/or techniques. It is, of course, not possible to describe every conceivable combination of components and/or methods for purposes of describing the various elements of the disclosure, but it may be recognized that many further combinations and permutations of the disclosed elements are possible. Accordingly, it may be apparent that various modifications may be made to the disclosure without departing from the scope thereof. In addition, or as an alternative, other embodiments of the disclosure may be apparent from consideration of the specification and annexed drawings, and practice of the disclosure as presented herein. It is intended that the examples put forth in the specification and annexed drawings be considered, in all respects, as illustrative and not limiting. Although specific terms are employed herein, they are used in a generic and descriptive sense only and not for purposes of limitation.

What is claimed is:

1. A device for transporting a user, the device comprising:
a base configured to support the user, the base having a first portion and a second portion, the first portion configured to rotate with respect to the second portion to transition between a first base position and a second base position;
a handle assembly coupled to the base and having a wheel and a handle; and
a wheel assembly having a set of wheels, the wheel assembly coupled to the base and configured transition between a first wheel position and a second wheel position;
wherein the base is configured to transition between the first base position and second base position and the wheel assembly is configured to transition between the first wheel position and the second wheel position to form a first orientation configured to support the user in a seated position and a second orientation configured to support the user in a standing position.

2. The device of claim 1, further comprising a set of pedals coupled to the wheel, wherein the set of wheels is two wheels, the first orientation is a tricycle orientation, and the second orientation is a scooter orientation.

3. The device of claim 1, wherein in the first orientation a portion of the base is positioned below at least a portion of the set of wheels and in the second orientation the base positioned above the set of wheels.

4. The device of claim 3, further comprising a removable pusher configured to couple to the base, wherein when the removable pusher is coupled to the base, the base is configured to transition between the first base position and second base position and the wheel assembly is configured to transition between the first wheel position and the second wheel position to form a stroller orientation with the base positioned above the set of wheels.

5. The device of claim 1, wherein the base has a third portion configured to receive the handle assembly and rotate with respect to the handle assembly about a first axis.

6. The device of claim 5, wherein the third portion of the base is configured to rotate with respect to the second portion of the base and the first portion of the base rotates with respect to the second portion of the base independent of the third portion.

7. The device of claim 1, wherein the wheel assembly includes two wheels and each of the two wheels is configured to independently and removably couple to the base.

8. The device of claim 7, wherein in the first wheel position the two wheels are coupled to an outer portion of the base and in the second wheel position the wheels are coupled to an inner portion of the base.

9. The device of claim 1, further comprising a seat configured to be removably coupled to the base.

10. The device of claim 1, wherein the second portion of the base has a first side and a second side, the first side configured to support the user in the seated position and a second side configured to support the user in the standing position.

11. The device of claim 10, wherein the wheel assembly is coupled to the second side of the base and the wheel assembly is configured to rotate with respect to the base between the first wheel position and the second wheel position.

12. The device of claim 11, wherein the second portion of the base has a spring lock configured to compress to permit the wheel assembly to rotate between the first wheel position and the second wheel position and configured to expand to lock the wheel assembly into the first wheel position and the second wheel position.

13. The device of claim 1, wherein the wheel assembly includes first arm coupled at a first end to the base and at a second end to a first wheel and a second arm connected at a third end to the base and at a fourth end to a second wheel and wherein the second wheel is coupled to the first wheel via a telescoping arm.

14. The device of claim 1, wherein the handle has a shaft and a hinge separating the shaft into a first shaft portion and a second shaft portion.

15. A device for transporting a user, the device comprising:
a handle assembly having a wheel, a shaft coupled to the wheel, and a handle coupled to the shaft;
a base configured to support the user and to selectively couple to the shaft at a first shaft position and a second shaft position, the shaft configured to rotate with respect to the base; and
a wheel assembly having a first arm coupled to a first wheel and a second arm coupled to a second wheel, the wheel assembly coupled to the base and configured rotate with respect to the base between a first wheel position and a second wheel position;
wherein the device is configured to transition from a first orientation configured to support the user in a seated position when the base is positioned at the first shaft position and the wheel assembly is positioned in the first wheel position to a second orientation configured to support the user in a standing position when the base is positioned at the second shaft position and the wheel assembly is positioned in the second wheel position.

16. The device of claim 15, further comprising a set of pedals coupled to the wheel, wherein the first orientation is a scooter orientation and the second orientation is a tricycle orientation.

17. The device of claim 15, wherein in the first orientation a portion of the base is positioned below at least a portion of the set of wheels and in the second orientation the base positioned above the set of wheels.

18. The device of claim 17, further comprising a removable pusher configured to couple to the base.

19. The device of claim 18, wherein when the removable pusher is coupled to the base, the wheel assembly is positioned in the first wheel position, the first orientation is a stroller orientation.

20. The device of claim 15, wherein the first arm and the second arm are configured to move apart and toward one another.
